(19) United States
(12) Patent Application Publication
(10) Pub. No.: US 2009/0065972 A1
(43) Pub. Date: Mar. 12, 2009

(54) METHOD FOR MANUFACTURING A CONSTRUCTION BOARD

(76) Inventors: Michael E. Feigin, The Woodlands, TX (US); John Wisenbaker, JR., Kingwood, TX (US); Russell Subjinske, Blacklick, OH (US)

Correspondence Address: HAYNES AND BOONE, LLP;IP Section, 2323 Victory Avenue, Suite 700, Dallas, TX, 75219, US

(21) Appl. No.: 12/235,257

(22) Filed: Sep. 22, 2008

Related U.S. Application Data
(63) Continuation-in-part of application No. 11/772,987, filed on Jul. 3, 2007.

(51) Int. Cl. B28B 5/00

(52) U.S. Cl. 264/241

(57) ABSTRACT

A method for manufacturing a construction board includes mixing a first cement mixture comprising magnesium oxide and magnesium chloride, mixing a second cement mixture comprising magnesium oxide, magnesium chloride, a binding agent, and at least one filler, the second cement mixture being thicker in consistency than the first cement mixture, dispensing a first layer of the first cement mixture onto a mold, and dispensing a first layer of reinforcing mesh onto the first layer of the first cement mixture, the reinforcing mesh being sized to allow the first cement mixture to at least partially pass through the reinforcing mesh layer. The method may further include dispensing a layer of the second cement mixture over the first layer of the first cement mixture, dispensing a second layer of the first cement mixture onto the layer of the second cement mixture, dispensing a second layer of reinforcing mesh onto the second layer of the first cement mixture and allowing at least a portion of the second layer of the first cement to flow through the mesh, drying the cement based board.

### CROSS REFERENCE TO RELATED APPLICATIONS

This application is a continuation-in-part of U.S. patent application Ser. No, 11/772,987 filed Jul. 3, 2007, the entire disclosure of which is incorporated herein by reference to the extent not inconsistent with the present invention.

### BACKGROUND

Homes and other types of structures are fabricated from a variety of materials. Typical materials include, for example, gypsum wallboard and silicate-based products. Conventional gypsum wallboard, while generally satisfactory for its intended use, unfortunately can be easily and permanently damaged from water, fire, or blunt force (e.g., a chair knocking into the wall). Also, it has been reported that products that contain silicate in some situations may be harmful to humans or to the environment. Accordingly, special precautions must be taken to minimize the harmful effects to construction workers that work with silicate-based products.

Therefore, there is a need for a construction board that provides improved resistance to water, fire, and blunt force damage, while maintaining many of the positive characteristics provided by conventional gypsum boards.

### SUMMARY

In accordance with an exemplary embodiment of the invention, a construction board is formed from a composition having the following ingredients: magnesium oxide, magnesium chloride, a binding agent (e.g., perlite), water, and wood shavings or recycled board scraps. The construction board also includes fiberglass and/or polypropylene sheets on opposite sides of the construction board. Perlite, which may be used as a binding agent for the construction board of the invention, is a generic term for naturally occurring siliceous rock. The distinguishing feature which sets perlite apart from other volcanic glasses is that when perlite is heated to a suitable point in its softening range, perlite will expand from 4 to 20 times its original volume. The expansion is generally due to the presence of 2 to 6% combined water in crude perlite rock, and therefore, when quickly heated to temperatures above about 1600° F., the crude rock pops in from the combined water vaporizing. Expanded perlite can be manufactured to weigh as little as 2 pounds per cubic foot, and since perlite is a form of natural glass. It is classified as chemically inert and generally has a pH of approximately 7.

Embodiments of the invention may further provide a method for manufacturing a construction board includes mixing a first cement mixture comprising magnesium oxide and magnesium chloride, mixing a second cement mixture comprising magnesium oxide, magnesium chloride, a binding agent, and at least one filler, the second cement mixture being thicker in consistency than the first cement mixture, dispensing a first layer of the first cement mixture onto a mold, and dispensing a first layer of reinforcing mesh onto the first layer of the first cement mixture, the reinforcing mesh being sized to allow the first cement mixture to at least partially pass through the reinforcing mesh layer. The method may further include dispensing a layer of the second cement mixture over the first layer of the first cement mixture, dispensing a second layer of the first cement mixture onto the layer of the second cement mixture, dispensing a second layer of reinforcing mesh onto the second layer of the first cement mixture and allowing at least a portion of the second layer of the first cement to flow through the mesh, drying the cement based board.

Embodiments of the invention may further provide a method for manufacturing a cement based construction board. The method may include mixing a magnesium oxide based cement mixture, dispensing a thin layer of the magnesium oxide based cement mixture onto a mold, positioning a reinforcing mesh layer on the thin layer and allowing a portion of the thin layer to pass through the reinforcing mesh layer, dispensing a thick layer of the magnesium oxide based cement having a filler material in the cement mixture onto the previously deposited thin layer containing the reinforcing mesh, dispensing another thin layer of the magnesium oxide based cement mixture onto the thick layer, and positioning another layer of reinforcing mesh on the thin layer and allowing a portion of the thin layer to pass through the reinforcing mesh.

Embodiments of the invention may further provide a method for manufacturing a cement based construction board. The method may include mixing a first cement mixture of magnesium oxide based cement, mixing a second cement mixture of magnesium oxide based cement having a filler material, the second cement mixture being thicker than the first cement mixture, dispensing a thin layer of the first cement mixture onto a substantially planar mold, and positioning a layer of reinforcing mesh on an upper surface of the thin layer and allowing at least a portion of the thin layer to permeate the reinforcing mesh. The method may further include dispensing at least one thick layer of the second cement mixture onto the thin layer, dispensing another thin layer of the first cement mixture onto the thick layer, positioning a layer of reinforcing mesh on the thin layer and allowing the and allowing at least a portion of the thin layer to permeate the reinforcing mesh, pressing the layers of cement to a predetermined and substantially uniform thickness, drying the layers of cement for a predetermined period of time, removing the layers of cement from the mold, and cutting the layers of cement into predetermined board sizes.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 shows a perspective view of a construction board fabricated in accordance with the exemplary embodiment of the invention;

FIG. 2 shows a cross-section a view of the construction board of FIG. 1;

FIG. 3 shows a perspective view of a mold used in the fabrication of the construction board;

FIG. 4 shows a fabrication station at which one or more of the construction boards can be fabricated;

FIG. 5 shows a exemplary method of fabricating the construction board;

FIG. 8 illustrates an interim step during the fabrication of the construction board in which plastic strips are laid on opposite ends of the board;

FIG. 7 illustrates two molds placed end-to-end to fabricate multiple boards simultaneously;

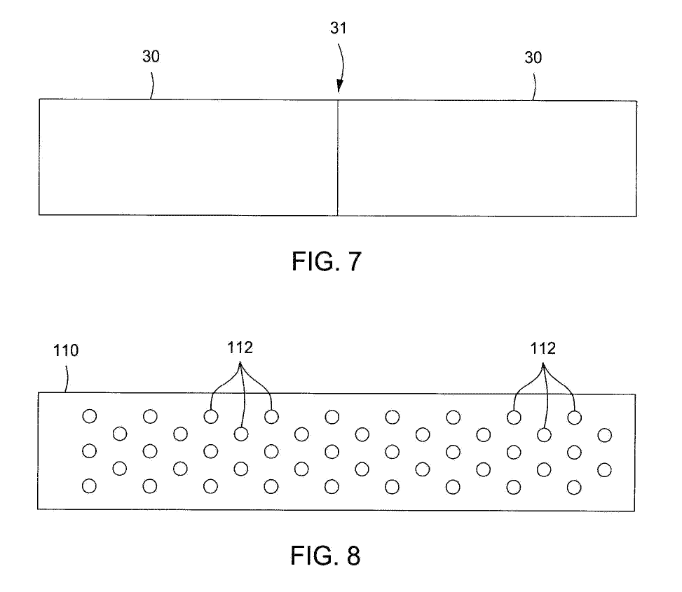

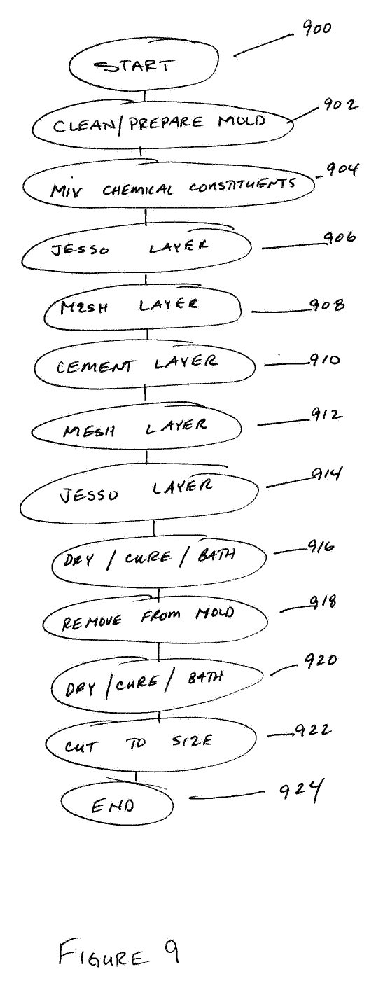

FIG. 8 shows a exemplary embodiment of the construction board fabricated to be used as fascia board; and

FIG. 9 illustrates a flowchart of an exemplary method for manufacturing a construction board of the invention.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in various ways, i.e., any element from one embodiment may be used in any other embodiment, without departing from the invention.

Additionally, certain terms are used throughout the following description and claims to refer to particular components. As one skilled in the art will appreciate, companies may refer to a component by different names. This document does not intend to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values. Accordingly, various embodiments of the invention may deviate from the numbers, values, and ranges disclosed herein.

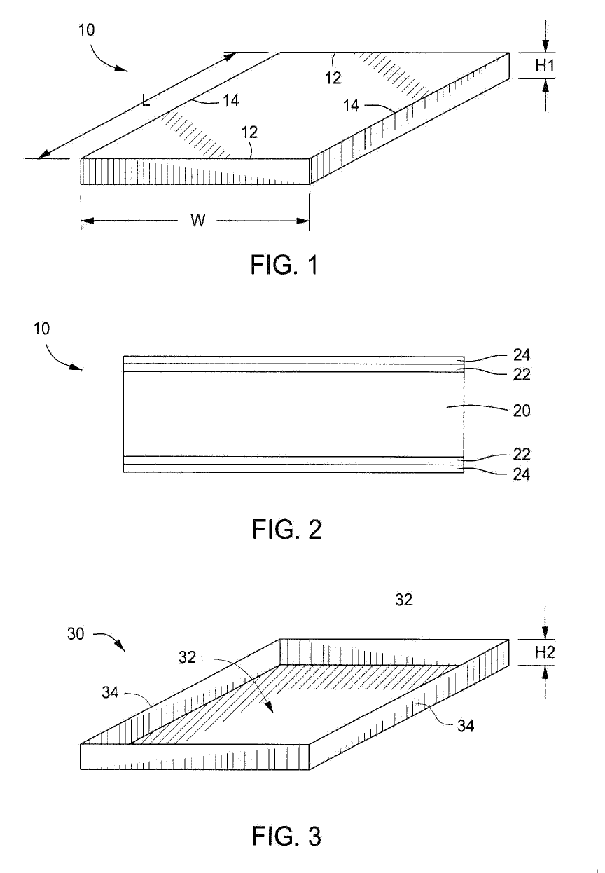

FIG. 1 shows a construction board 10 fabricated in accordance with a exemplary embodiment of the invention. The construction board 10 is made from a composition comprising one or more of the following ingredients: magnesium oxide, magnesium chloride, a binding agent (e.g., wood shavings), perlite, recycled board scraps, and water. In one embodiment, for example, the construction board comprises a combination of magnesium oxide, magnesium chloride, water, perlite, and a binding agent. In another exemplary embodiment, the construction board comprises magnesium oxide, magnesium chloride, water, perlite, a binding agent, and ground up, construction board scraps. Exemplary amounts of the various ingredients are provided below.

The construction board 10 can be used in a variety of ways during the fabrication of a structure such as a house or other type of building. Without limitation, such uses include interior wall board, structural sheathing, soffit board, exterior siding, fascia board, tile backer board, decking for countertops, radiant barrier sheathing, structural wrap, stucco wrap, window wrap, ceiling tile, and billboard backer. Because of the ingredients comprising the construction board 10, the resulting board is generally fire and water-resistant and substantially more durable than conventional gypsum wall board. Further, in at least some embodiments, the construction board 10 is free of, or at least substantially free of, any combination, or all, of the following: silicate (including magnesium silicate), natron, and cement. Without silicate, the exemplary embodiment of the construction board does not have the potential for human harm attributable to silicate-based products. Natron is a naturally occurring mixture of sodium carbonate decahydrate (Na₂CO₃.10 H₂O, a naturally occurring form of soda ash) and about 17% of sodium bicarbonate, ong with small quantities of household salt. Natron is generally white to colorless when pure, varying to gray or yellow when impurities are present. Natron deposits occur naturally as a part of saline lake beds in and environments. In mineralogy, the term natron is the term used for only the prevailing hydrated sodium carbonate (i.e. sodium carbonate decahydrate) found in the historical salt.

By way of definition, the construction board 10 depicted in FIG. 1 has a length L, width W, and height H1. The dimensions L, W, and H1 can be varied to suit any particular needs. In at least one embodiment, L, W, and H1 are approximately 8 feet, 4 feet, an one-half inch, respectively.

FIG. 2 shows a cross-sectional view of the construction board 10. As shown, the board comprises a center portion 20 which generally comprises the composition of the various ingredients as described below. A pair of fiberglass sheets 22 is also included on opposite sides of the board 10. Further still, a pair of polyester paper sheets 24 is also included adjacent the fiberglass sheets 22. In at least some embodiments, the fiberglass sheets 22 may be sufficiently porous to permit some of the composition 20 to permeate the fiberglass sheets.

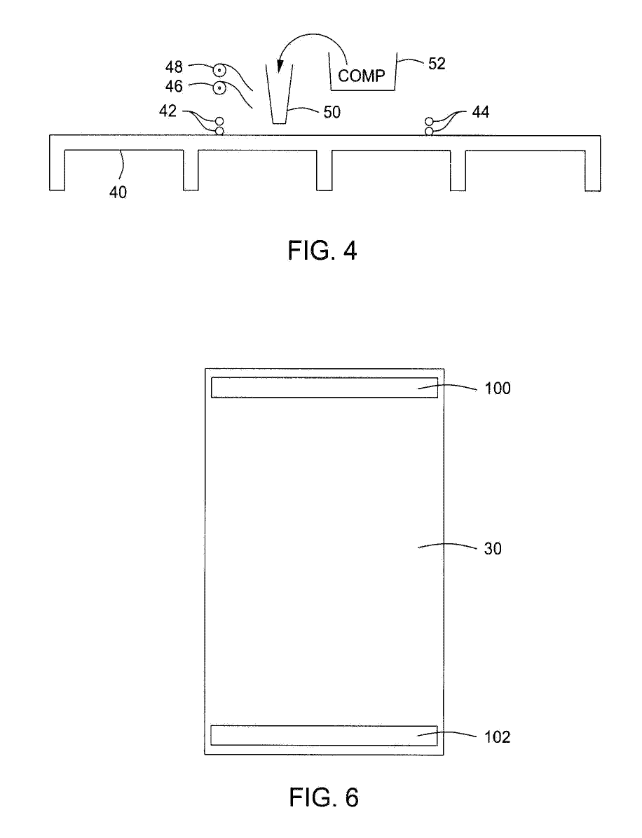

The following discussion describes a exemplary method for fabricating the construction board 10. FIGS. 3 and 4 depict at least some of the equipment used to fabricate the construction board 10, FIG. 3 illustrates a mold 30 that is used. The mold may comprise a plastic (or other suitable material) flat sheet and, in some embodiments, may have lips white in other embodiments not have lips. The lips function to help define the thickness of the board. When mixed together, the constituent ingredients form a mixture that is viscous enough so that, in some embodiments, the lips are not needed—the mixture can be formed to any suitable thickness without the use of lips on the mold. As shown in FIG. 3, the mold has a base 32 and lips 32 and 34 that protrude up from the base 32. The length and width dimensions of the mold 30 approximate the desired dimensions of the construction board 10. The height H2 of the mold, however, may be less than the desired height H1 of the construction board.

FIG. 4 shows a production line table 40 usable to fabricate the construction board 10. The table 40 preferably is of a length longer than the desired length of the construction board. Two pairs of rollers 42 and 44 are also included between which the mold will pass as will be described below. Rolls 48 and 48 contain fiberglass and polypropylene, respectively, which are used during the fabrication of the board. The mold 30 is passed along the table 40 between the rollers as described herein. Spout 50 receives the composition from a mixing chamber 52. Through the spout 50, the composition can be poured onto the mold 30 as it passes along fable 40.

In some embodiments, boards are made using ground up excess portions (e.g., scraps) from prior fabrication processes of construction boards. That is, as the boards are cut to size, the left-over scraps are ground up and reused to make future boards. In other embodiments, recycled board scraps are not used. In a exemplary embodiment, the construction board 10 comprises the ingredients listed below in Table 1. The kilogram values represent sufficient materials to fabricate four boards that are each approximately 4 feet wide by 8 feet long by 12 millimeters (mm) thick). The relative proportions (in “parts”) are also provided. The column labeled “without recycling” refers to the ingredients used to make the boards without reusing left-over board scraps from prior fabrication processes. The column labeled “with recycling” refers to the ingredients used to make the boards while reusing left-over board scraps from prior fabrication processes.

TABLE 1
EXEMPLARY BOARD INGREDIENTS

| | |
|---|---|
| Without Recycling | With Recycling |

| | Parts by | Amount | Parts by | Amount |
|---|---|---|---|---|
| | Weight | (Kg) | Weight | (Kg) |
| Magnesium | 7 | 105 | 10 | 100 |
| oxide | | | | |
| Magnesium | 3 | 45 | 4 | 40 |
| chloride and | | | | |
| water mixture | | | | |
| Perlite | 1.67 | 25 | 2 | 20 |
| Binding agent | 1 | 15 | 1 | 10 |
| Recycled Board | n/a | n/a | 2 | 20 |
| Scraps | | | | |

The magnesium oxide, magnesium chloride, and perlite ingredients are generally initially in powder form. In at least some embodiments, the magnesium oxide that is used may comprise, by weight, 89.1% magnesium, 5.3% silicon, 3.9% calcium, 1% iron, 0.2% 138385.01/2356.00400 5 chloride, 0.2% sulfur, 0.2% cobalt, and 0.1% gallium. The size of the magnesium oxide particles used to make the construction board may be in the range from approximately 1 μm to approximately 50 μm. The magnesium chloride preferably comprises, by weight, 64.5% chloride, 23.2% magnesium, 8% sodium, 2.4% sulfur, 1.2% potassium, 0.3% bromine, 0.2% aluminum, 0.1% iron, and 0.1% calcium. Preferably, the size of the magnesium chloride particles used to make the construction board are in the range from approximately 0.5 μm to approximately 3 μm. The perlite preferably comprises, by volume, 84% silicon, 14.2% potassium, 10.9% aluminum, 3.8% sodium, 3.2% iron, 2.5% calcium, 0.5% arsenic, 0.3% titanium, 0.3% manganese, 0.1% rubidium, and 0.1% zirconium. Preferably, the size of the perlite particles used to make the construction board are in the range from approximately 2 μm to approximately 8 μm. The binding agent functions to bind the composition together and may comprise wood shavings although binding agents other than wood shavings may be used in this regard as desired.

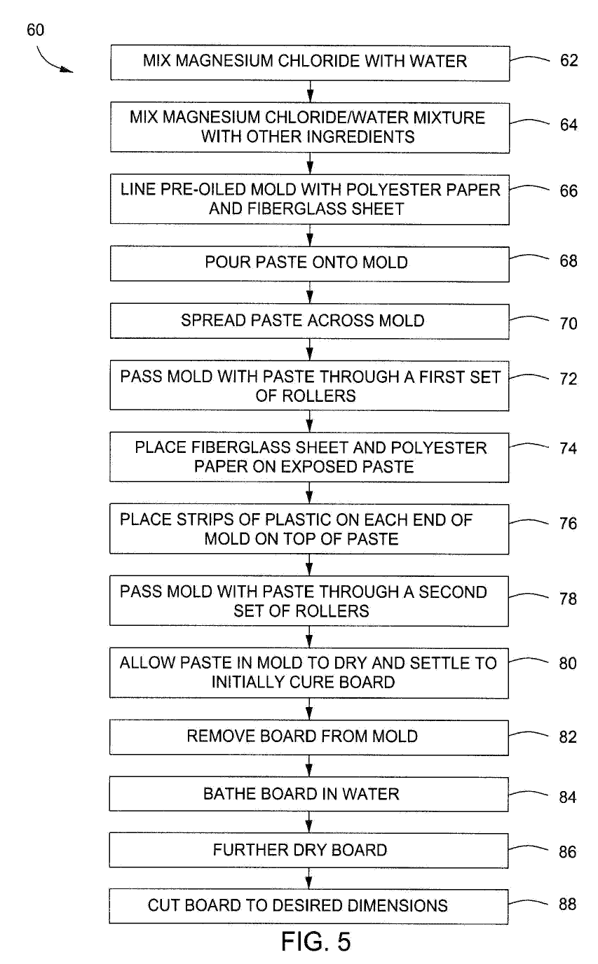

FIG. 5 illustrates a method 60 for fabricating the construction board 10 in accordance with a exemplary embodiment of the invention. Method 60 includes a plurality of actions 62-88, which will be described below. The order of least some of the actions of method 80 can be varied from that shown and at least some of the actions may be performed sequentially or concurrently. The amounts of each ingredient described in FIG. 5 is in accordance with the amounts in Table 1 and depends on whether recycled ground up board scraps are used.

At 62, the method includes mixing magnesium chloride with water in a mixing chamber (which may be different from mixing chamber 52 in FIG. 4) to form a solution. Tap water may be used. For every 10 Kg of magnesium chloride, approximately 0.9 cubic meters of water is used to form the solution. The magnesium chloride and water solution is stirred periodically over a period of time, such as 8 hours, to let any impurities rise to the surface. Such impurities preferably are removed.

At 64, the magnesium chloride/water solution is mixed in mixing chamber 52 with the remaining ingredients listed in Table 1, which may or may not include recycled board material as noted above, to form a paste. If wood shavings are used as the binding agent, the wood shavings preferably are filtered through a sieve to trap large pieces of wood and other non-timber impurities. The resulting paste is mixed for enough time (e.g. a few minutes) until the mixture achieves a cake mix-like consistency.

Action 66 comprises lining a pre-oiled mold (e.g., mold 30) with a polyester paper sheet and a fiberglass sheet on top of the polyester paper. This action can be performed by placing the pre-oiled mold 30 on table 40 and unrolling a suitable length of each of rolls 46 and 48 on to the mold. The mold 30 may be pre-oiled with any suitable oil or other material that reduces the propensity for the composition to stick to the mold. An example of a suitable oil for this purpose comprises 1 part engine oil to 10 parts water.

After the paste has settled in the mixing chamber 52, the paste is then poured onto the mold (action 68). The paste will be relatively thick and will thus remain in a pile on the mold 30 to a height that may be greater than the height H2 of the mold. At 70, the paste is spread across the mold 30 in accordance with any suitable technique such as by using a wooden or plastic board to push the paste around to spread it out as desired. At 72, the mold 30 with paste is then passed through a first pair of rollers 42. The spacing of the rollers in roller pair 42 is such that the paste is spread around on the mold to roughly approximate the desired height H1 for the resulting construction. This action may result in some of the paste spilling over the edges of the mold. Once the mold 30 has passed through the first pair of rollers 42, at 74 another sheet of fiberglass is unrolled and placed on the exposed surface of the paste in the mold. Further, another sheet of polyester paper is unrolled onto the fiberglass sheet.

At 78, a pair of plastic strips are placed on opposite ends of the mold on top of the paste as shown in FIG. 6. FIG. 6 shows a top view of the mold 30 with paste therein. A pair of plastic strips 100 are placed on the paste in the mold at opposite ends of the mold as shown. The plastic strips 100 generally run the width of the mold and function to maintain the end edges of the paste generally even prior to passing the mold through a second set of rollers. Referring again to FIG. 5, the mold 30 is then passed through a second set of rollers 44 (78). Rollers 44 preferably are spaced closer together than rollers 42 and are spaced apart at a distance that is equal to, or approximately equal to, the desired thickness H1 of the resulting construction board 10. After the mold is passed through the second pair of rollers 44, the paste in the mold has a thickness that is at least approximately the desired thickness of the construction board. The plastic strips 100 can then be removed. Both pairs of rollers 42 and 44 are preferably constantly moisturized to minimize or prevent the composition from sticking to the rollers. For example, water can be sprayed on the rollers for this purpose.

The paste is permitted to dry and settle to initially cure the board at 80. The board is dried preferably for approximately 8 hours, although this time can be varied depending on the ambient temperature and humidity. At 82, the board is removed from the mold. At 84, the board is bathed in water (e.g., a concrete tank) for approximately 8 to 12 hours depending on the thickness of the board. Thicker boards are bathed for a longer periods of time than thinner boards. The bathing process is a post-curing “cooling” down process that also allows the materials in the composition to further bond and for impurities in the board to be removed. After the bath, the board is further dried (86). This final drying action can be performed by placing the board outside in preferably sunny weather for approximately 2 to 3 days. This final drying step serves to cause all, or substantially all, water to evaporate from the board. Finally, the board is trim cut to the desired dimensions (88). The board scraps removed during the trimming process can be ground to a power form and used as one of the constituent ingredients as noted above.

If desired, multiple boards may be fabricated on table 40 generally simultaneously. To fabricate multiple boards concurrently, multiple molds are used and placed end-to-end as illustrated in FIG. 7. Then, method 100 of FIG. 5 can be performed by pouring the composition across both molds in act 68. After placing the fiberglass and polypropylene sheets on the exposed paste across both molds, the paste is cut along seam 31 to separate the two molds. Then, actions 76-88 can be performed on each separate mold albeit generally simultaneously.

As noted above, multiple uses are possible for the construction board made from the composition described herein. By way of example, FIG. 8 shows a board 110 formed into a board suitable for use as a soffit board on a house. Holes 112 are drilled into the board 110 for airflow. A suitable texture material can be applied to the board to make the board aesthetically suitable as ceiling tile and the like. The construction board 10 of the exemplary embodiment can be cut with any conventional saw suitable for cutting wood and can be nailed in place using wood nails.

In another exemplary embodiment of the invention, the manufacturing process and/or the equipment used to manufacture the construction boards of the invention may modified to produce a board having a smooth surface on one side and a rough or textured surface on another side. For example, when the boards of the invention are manufactured, the magnesium oxide mixture is poured onto a mold and processed through one or more rollers to finalize the thickness and/or shape of the board, as discussed above. However, in the current exemplary embodiment, the mold upon which the magnesium oxide mixture is poured onto may be configured to have a rough or textured surface that is configured to receive the magnesium oxide mixture thereon. The rough or textured surface may be used to create a texture on the outer surface of the manufactured board. Generally, the texture of the mold will be an inverse of the texture generated on the board, as the inversions in the mold will be filled with the magnesium oxide mixture and will generate a protrusion extending from the board once we mold is removed from the board in the manufacturing process. The rough or textured surface of the mold may be used to create a wood grain surface, a simulated tile surface, simulated brick-like a surface, a simulated stucco surface, or any other desired pattern or texture on the outer surface of the board.

In an exemplary embodiment of the invention, when construction boards are manufactured having at least one rough or textured surface, the process of manufacturing the construction boards may be slightly modified from a conventional manufacturing process. For example, in embodiments of the invention where the construction board of mold does not have a smooth surface, within the magnesium oxide cement mixture tends to stick to the mold with greater frequency. As such, in embodiments of the invention where a rough surfaced mold is used, a means for preventing the magnesium oxide-based cement mixture from sticking to the mold may be used. In one embodiment the mold may be lubricated with a releasing agent, such as an oil, prior to pouring (or otherwise positioning) the magnesium oxide-based mixture of thereon, in another embodiment of the mold may be covered with a thin sheet of polyethylene, polyurethane, or other thin sheet of material, wherein the material is configured to prevent the magnesium oxide mixture from sticking to the mold, white also allowing the mixture to fall into the crevices of the rough surfaced mold. In another exemplary embodiment of the invention, the thin sheet may be rolled on to the rough surfaced mold so that the thin sheet is essentially an arrest into the crevices of the mold.

Exemplary liquid lubricants (releasing agents) that may be used for the mold include petroleum lubricants containing about 90% base oil (mineral oils) and less than 10% additives, natural lubricants such as lanolin and water, synthetic oil lubricants, vegetable oils or synthetic liquids such as hydrogenated polyolefins, esters, silicone, fluorocarbons, and Teflon-type sprays. Exemplary non-liquid lubricants include grease, dry graphite, PTFE (Teflon), molybdenum disulfide, tungsten disulfide, air cushion, and wax paper. Other exemplary dry lubricants include graphite, molybdenum disulfide, and tungsten disulfide.

In another exemplary embodiment of the invention, the textured or rough surface may be applied to magnesium oxide-based material after the material is poured onto the mold and smoothed by at least a first set of rollers. For example, a roller having a texture formed on an outer surface thereof may be positioned in the manufacturing line downstream of the mixture pouring and roiling processes that are configured to generate a smooth board having a uniform thickness. The textured roller may be applied or roiled over the surface of the smoothed board while the magnesium oxide-based cement mixture is still soft, thus applying a texture to the board that is an inverse of the texture on the outer surface of the roller.

In each of the above noted textured boards, embodiments of the invention contemplate that either one or both sides of the manufactured board maybe textured or smooth. Further, the texture applied to one side may be different than the texture applied to the opposing side. For example, a first side of the board may be textured via the mold to apply a wood-grain or other stylized finish the thereto, while the opposing side of the manufactured board (the side facing the wall) maybe textured with a roller to create a surface that is more amenable to adhesive or glue type installation techniques.

In an exemplary embodiment of the invention, the process of manufacturing the construction board may include sealing and/or painting the outer surfaces of the construction board once the manufacturing and curing processes are completed. More particularly, once the curing process for the magnesium oxide-based construction board has been completed and the board is sufficiently dried, the magnesium oxide-based construction board of the invention may be treated with a plurality of chemical constituents. For example, the magnesium oxide-based construction board may be treated with an antibacterial agent to prevent what you're from being absorbed into the porous material and causing bacterial growth, such as mold. Exemplary antibacterial materials that may be applied to the construction board include, but are not limited to, bleach solutions, sulfur solutions, 3-(trimethoxysilyl) propyldimethyioctadecyl ammonium chloride, quats, heavy metals, peroxides, phenols, triclosan, formaldehydes, and any other chemical agent that may be applied to building materials to prevent mold growth.

Additionally, in another embodiment, in conjunction with (or separately) the antibacterial agent, a sealant material may be applied to the construction board. The sealant material may be configured to seal the outer surface of the board from exterior elements, thus preventing water from penetrating the outer surface (or least into the inferior porous portion) of the board, which substantially reduces the ability of bacteria and/or mold to grow on the board. In yet another embodiment, the outer surfaces of the manufactured board may be primed with a paint or other material configured to prevent mold, seal the board, and/or add color to the outer surface of the board. The painting process may be conducted after the manufacturing and curing (or drying) processes for the board have been completed, such that the magnesium oxide-based material has fully cured and hardened prior to the application of the mold reducer, sealer, or paint thereto.

In another exemplary embodiment of the invention, the magnesium oxide mixture that is used as the base or foundation for the construction board of the convention may also contain foaming agents or de-foaming agents, collectively referred to as foam adjusting agents. In one configuration of the present exemplary embodiment, the foaming or de-foaming agents may be used to control the quantity of gas contained in the magnesium oxide mixture. More particularly, defoaming agent added to the magnesium oxide mixture may operate to reduce the number of air bubbles in the magnesium oxide mixture. Conversely, a foaming agent added to the magnesium oxide mixture may operate to increase the number of air bubbles present in the magnesium oxide mixture.

This ability to control the quantity of air bubbles in the magnesium oxide mixture may be used to adjust the density of the resulting construction board. More air bubbles in the magnesium oxide mixture results in a lighter weight board, however, the increased bubble concentration also makes the resulting board more brittle, as the as the crystals don't interlock as well with the interspersed bubbles, if a lighter board is required, then the board may have additional layers of the mesh added to compensate for the increased brittleness of the board that inherently results from the addition of more air bubbles into the mixture of the construction board of the invention. For example, in a typical one inch thick manufactured construction board, there may be about 4-6 independent layers of mesh. As such, for a lighter board that has an increased bubble concentration from the addition of a foaming agent info the construction board mix, such as a half inch thick backer board manufactured with a foaming agent present in the mixture, there may be about 4 to 10 layers of mesh.

The density of the resulting magnesium oxide-based construction board is directly related to both the weight of the board and the strength or rigidity of the board. Thus, the ability to add foaming or de-foaming agents to the magnesium oxide mixture allows for adjustment of the weight, flexural strength, and rigidity of the boards manufactured from the exemplary methods described herein. One exemplary defoaming agent is commonly known as smokeless gunpowder. Exemplary foaming agents include surfactants such as wherein the surfactant comprises sodium lauryl ether sulfate, sodium dodecyl sulfate, ammonium lauryl sulfate, and any combination thereof. These surfactants are known to facilitate the formation of a foam, or enhance its colloidal stability by inhibiting the coalescence of bubbles. Other foaming agents include materials that decompose to release a gas under certain conditions, and therefore, turn a liquid into a foam.

In another exemplary embodiment of the invention, the fiberglass sheet described with regard to action 66 above may be a plurality of fiberglass sheets positioned in layers. For example, in one exemplary embodiment of the invention, a fiberglass sheet or sheets positioned on each side of the magnesium oxide-based construction board may comprise a fixed mesh or a woven mesh. The mesh is generally positioned across the board, i.e., when a board is being molded the mesh is laid over substantially all of the board surface. As such, when a board sheet is formed, for example, the mesh will generally be positioned inside the board and extend across substantially the entire (internal) area of the board. Generally speaking, fixed mesh generally includes a plurality of intersecting strands, wherein intersecting strands are attached to each other at the point of intersection. Similarly, woven mesh generally includes a plurality of intersecting strands that are free to move with respect to each other at the intersecting points. Since fixed mesh does not move at the intersecting points, fixed mesh has been shown to provide a more rigid and less flexible construction board. Conversely, when woven mesh is used in construction boards, if has shown to provide a more flexible and less rigid construction board, as the intersecting points of the mesh are allowed to move with respect to each other. Both fixed and woven mesh sheets used in exemplary embodiments of the invention are generally referred to herein as reinforcing mesh.

The mesh sheets may be positioned in the interior of the magnesium oxide based construction board, and are generally positioned to be parallel to be outer surface (the large area side) of the construction board. The mesh sheets may be positioned proximate the surface of the large area side of the magnesium oxide-based construction board, and may be positioned on one or both sides of the magnesium oxide-based construction board. Additionally, in at least one exemplary embodiment of the invention, the magnesium oxide-based construction board may also have one or more mesh sheets positioned in a central interior portion of the magnesium oxide-based construction board, i.e., one or more mesh sheets may be in the middle of the magnesium oxide-based construction board, and the board may still contain one or more mesh sheets positioned proximate the large area surface of board.

The mesh used in various embodiments of the invention may have varying sizes and dimensions. The mesh may have a particular number of boxes or grids per unit of area. For example, exemplary mesh that may be used in the exemplary embodiments described herein include mesh having 2, 4, 8, 8, 9, 10, 12, 14, 16, or 64 grids per square centimeter. Additionally, the mesh may be sized to 2×2, 6×8, or 9×9, for example. The mesh may be manufactured from nylon, polyester, fiberglass, nylox, cloth, wool, hemp, or any other material commonly used to form a mesh-type material.

In at least one embodiment of the invention, the mesh may be sized to allow the magnesium oxide mixture (without the fillers) to permeate the mesh. More particularly, during an exemplary manufacturing process, a layer of jesso (a mixture of the core magnesium oxide based cement components without the fillers that generally has a viscosity that is thinner than the complete magnesium oxide cement) is often dispensed onto the board mold. Thereafter, a layer of mesh may be positioned in the jesso layer, is some embodiments it is preferred that the mesh have sufficient openings to allow the jesso to flow through the mesh.

In another exemplary embodiment of the invention, the magnesium oxide-based mixture may include additives that add flexibility to the hardened magnesium oxide based mixture. For example, a latex-type material may be added to the magnesium oxide based mixture. Natural latex generally refers to a stable dispersion or emulsion of polymer micro-particles an aqueous medium, however, several man-made materials, such as various rubber materials, are similar to natural latex and will have the same impact upon the present exemplary embodiment. Adding latex or other rubber materials to the magnesium oxide-based mixture may operate to reduce the weight of the resulting board, as the latex or rubber material will generally have a lower density than the magnesium oxide-based material. Additionally, the latex and other rubber materials that may be used in the magnesium oxide-based mixture are also less rigid than the magnesium oxide material when cured, and as such, the addition of the latex or other rubber materials to the magnesium oxide-based construction board mixture may operate to increase the flexibility of the resulting boards.

The latex that may be added to the board cement mixture may be in a liquid form. The color of the liquid latex may be light, such as white or milky color and the liquid latex mixture may emit an acrylic odor. The pH of the liquid latex may be between about 9 and about 11, and more particularly, between about 9.3 and about 10.2. The liquid latex may have a boiling point of about 100° C. in water and may be noncombustible or explosive. The vapor pressure of the liquid latex may be about 2.266.4808 Pa at 20° C. water and the relative density may be between about 1 and about 1.2. Materials similar to latex that may be added to the magnesium oxide based construction board include PVA (poly vinyl acetate), acrylic, EVA (ethyl vinyl acetate), liquid rubber or other rubber substances, UVA, acrylic latex, and SBR latex.

The novel chemistry of the construction board of the invention may be configured to optimize the flexural strength for the particular board application. For example, a trim board may require a different flexural strength than a backer board. As such, the chemistry of the construction board of the present invention may be adjusted to cater the flexural strength of the construction board to the particular application of the board. Generally speaking, the flexural strength is also known as the modulus of rupture, bend strength, and/or fracture strength of a material. Flexural strength is generally measured in terms of stress, and therefore flexural strength is generally measured in Pascals (Pa). The value represents the highest stress experienced within the material at its moment of failure. In a bending test, the highest stress is reached on the surface of the sample.

In another exemplary embodiment of the invention, the magnesium oxide-based construction board may be manufactured to facilitate carbon capture and recycling. For example, a significant challenge facing nearly all manufacturing industries is emissions of carbon dioxide, a major greenhouse gas. Generally speaking, the process of carbon capture involves supporting a chemical reaction between carbon dioxide and other common materials to produce a third material that is not harmful to the environment. For example, carbon dioxide is often reacted with common silicates to produce silica and stable carbonates. Natural carbon sequestration occurs when carbon dioxide reacts with oceans, soils, forests, etc. However, for carbon dioxide to be sequestered artificially, i.e., not using the natural processes of the carbon cycle, the carbon dioxide must first be captured, or it must be significantly delayed or prevented from being re-released into the atmosphere (by combustion, decay, etc.) from an existing carbon-rich material, by being incorporated into an enduring usage (such as in construction). Thereafter it can be passively stored or remain productively utilized over time in a variety of ways.

In one exemplary embodiment of the invention, the magnesium oxide based construction board may be used to capture and store various components in the manufactured construction board of the invention. In this embodiment, the components captured by the construction board may be captured in the construction board of the invention without being chemically bonded to the board structure. For example, the cement mixture of the board may be used to capture or entrain various components in the cement mixture used to manufacture the construction board of the invention. For purposes of the various embodiments of the invention, entrapment is generally intended to mean the entrapment of one substance by another substance, where the first substance is generally consumed or contained within the second substance as a result of the entrapment.

For example, gases such as CO₂ or methane may be entrained in cement mixtures, such as the magnesium oxide based cement mixture used to manufacture the construction board of the invention. In one embodiment of the invention, gas entrainment of the construction board may include between about 5% and about 15% of the total volume of the construction board. In another embodiment, gas entrapment may account for between about 5% and about 10% of the total board volume. In yet another embodiment, gas entrainment may account for between about 10% and about 20% of the total board volume.

In another exemplary embodiment of the invention, the magnesium oxide based cement mixture may be used to entrain various compounds and constituents. For example, various compounds and constituents may be ground up and mixed into the magnesium oxide based cement mixture of the construction board of the invention. As an example, rubber, plastic, glass, pot ash, furnace ash, wood, rock, metals, and metal alloys may all be ground up into finely sized particles and included as fillers (entrained) in the magnesium oxide based construction board of the invention. Additionally, various other compounds and constituents may be ground up and used as filters in the cement mixture of the present invention. For example, ordinary trash or refuse may be ground up and included in the cement mixture of the construction board of the invention. Generally, any compound or constituent may be ground up and entrained in the construction board of the invention. For purposes of this disclosure, trash may include not only ordinary refuse, but any surplus or readily available material that is capable of being ground up into small pieces. In another exemplary embodiment of the invention, the magnesium oxide based cement material may contain carbonaceous materials as fillers.

In embodiments of the invention where compounds and constituents are ground up and entrained in the cement mixture of the construction board of the invention, the compounds and constituents are generally ground up into small particles sized to not have significant negative impact the structural integrity of the construction board. Generally speaking, the compounds and constituents may be ground up into particles having an average diameter of less than about 10 cm and greater than about 3 mm. Although the shape of the particles may vary as a result of the grinding process, the diameter dimension is generally used to represent the longest axial dimension across a particle. Generally speaking, ground or pulverized (which is intended to be included in ground particles) In another embodiment of the invention, the particles may have an average diameter of between about 1 mm and about 6 mm, in yet another embodiment of the invention, the particles may have an average diameter of between about 3 mm and about 4 mm, or between about 0.25 mm and about 1 mm. In other embodiments of the invention the ground material may ground to a powder form and have a much smaller diameter. Further, the cement mixture of the invention may be configured to contain between about 10% and about 20% by volume of the ground up compounds and constituents as filler material in another embodiment of the invention, the cement mixture of the invention may be configured to contain between about 5% and about 25% by volume of the ground up compounds and constituents as filler material, in yet another embodiment of the invention, the cement mixture of the invention may be configured to contain between about 10% and about 25% by volume of the ground up compounds and constituents as filler material.

In another exemplary embodiment of the invention, CO₂ gas may be added to the magnesium oxide based cement mixture. In this embodiment the CO₂ may react with constituents in the cement mixture to capture and permanently store the CO₂ in the construction board of the invention. The reaction of the CO₂ may form additional carbonates in the cement mixture. Further, the excess CO₂ gas may be entrained in the cement mixture as bubbles, as described herein.

In another embodiment of the invention, the magnesium oxide based construction board is configured to consume or permanently dispose of carbonate compounds, which are known to contain high amounts of CO₂. More particularly, during the manufacturing process, the magnesium and/or calcium carbonate actually permanently captures CO₂ in the board. This process of permanently capturing CO₂ enables the manufacturers of the construction boards of the invention to receive carbon credits. Thus, the overall manufacturing cost of the construction boards of the invention may be offset by the revenue generated by selling carbon credits related to the CO₂ captured and stored during the manufacture of the construction boards of the invention.

Carbon credits are generally known to be a key component of national and international emissions trading schemes that have been implemented to mitigate global warming. Carbon credits provide a way to reduce greenhouse effect emissions on an industrial scale by capping total annual emissions and letting the market assign a monetary value to any shortfall through trading. Credits can be exchanged between businesses or bought and sold in international markets at the prevailing market price. Credits can be used to finance carbon reduction schemes between trading partners and around the world. There are also many companies that sell carbon credits to commercial and individual customers who are interested in lowering their carbon footprint on a voluntary basis. These carbon offsetters purchase the credits from an investment fund or a carbon development company that has aggregated the credits from individual projects. The quality of the credits is based in part on the validation process and sophistication of the fund or development company that acted as the sponsor to the carbon project. This is reflected in their price; voluntary units typically have less value than the units sold through the rigorously-validated Clean Development Mechanism. Thus, the manufactured board of the invention can be used to reduce green house gases and to generate carbon credits (a financial benefit not provided by other boards), while still providing a manufactured board having superior physical properties over conventional manufactured boards.

In yet another embodiment of the invention, the cement mixture of the invention may be used to capture and store CO₂ gases. The capture and storage method for addressing green house gases is an approach that mitigates global warming by capturing carbon dioxide and storing it instead of releasing it into the atmosphere. Thus, the cement mixture of the present invention may be used to store CO₂ gases. More particularly, the CO₂ may be added to the cement mixture of the construction board in the form of bubbles injected into the mixture. The bubbles are trapped or stored in the mixture when the board cures and hardens, thus capturing and storing the CO₂. The CO₂ may be used to foam the mixture, as described herein, to provide lighter boards for some applications. The cement mixture of the invention may include up to 10% of CO₂ bubbles by volume in the mixture. In another embodiment, the cement mixture may include between about 1% and about 3% by volume of CO₂ bubbles in the board. In another embodiment, the cement mixture may include between about 1% and about 5% by volume of CO₂ bubbles in the board. In another embodiment, the cement mixture may include between about 0.5% and about 1.5% by volume of CO₂ bubbles in the board.

CCS applied to a modern conventional power plant could reduce CO₂ emissions to the atmosphere by approximately 80-90% compared to a plant without CCS. Capturing and compressing CO₂ requires much energy and would increase the fuel needs of a coal-fired plant with CCS by about 25%. These and other system costs are estimated to increase the cost of energy from a new power plant with CCS by 21-91%. These estimates apply to purpose-built plants near a storage location: applying the technology to preexisting plants or plants far from a storage location will be more expensive.

In another exemplary embodiment of the invention, the magnesium oxide-based construction board of the invention may be configured or otherwise manufactured with a grid or ruler thereon to allow for easy measurement during installation. More particularly, the perimeter of an exemplary board of the invention may be configured to include a ruler on each side thereof. The ruler on each side may include a plurality of raised hatch marks, wherein each of the raised hatch marks represent a specific length, such as an inch. These hatch marks may be formed in to the magnesium oxide-based construction board of the invention during the manufacturing process by adding corresponding recesses to the supporting the mold for the board. Each recess will be filled with the board mixture, and as such, when the mixture dries in the recesses and the mold is removed, the remaining material will form a hatch mark which may be used for the perimeter ruler of the present exemplary embodiment. The inventors contemplate that a plurality of hatch marks may be used to represent a plurality of different measurement increments. For example, hatch marks may be used to denote feet, inches, and fractions of inches around one or more sides of the perimeter of the construction board of the invention.

Additionally, in yet another exemplary embodiment of the invention, the magnesium oxide-based construction board of the invention may also be configured with a recessed grid that covers a substantial portion of a large area side of the construction board. Generally speaking, the large area side of a construction board may be defined as the side of the construction board that has the largest surface area. In another embodiment of the invention, the grid, which may be recessed or protruding, may be on either the large area side or a smaller area side or edge of the construction board, or both. To manufacture a construction board with a recessed grid or ruler, the mold supporting the construction board during the manufacturing process may be configured with a plurality of protrusions that are in the shape of the desired grid or ruler-type hatch marks. The grid or hatch marks (recessed or protruding) may generally be perpendicular to each other, and further, the spacing of the grid lines or the hatch marks may be spaced to correspond to predetermined measurement increments, in similar fashion to a ruler.

In another exemplary embodiment of the invention, the magnesium oxide based material used as the base material for the construction board may be manufactured to prevent bacterial growth on or in the construction board material. More particularly, the chemical constituents of the construction board base material (used to manufacture the board) may include a chemical compound that prevents bacterial or mold growth. One example of a board constituent that may be added to the exemplary construction board to prevent bacterial or mold growth is sulfur or sulfur containing compounds, in one embodiment of the invention the construction board may contain between about 2% and about 7% of sulfur by weight, where the sulfur acts as an insect repellent and assists with preventing mold and bacteria growth. In another embodiment, the construction board may contain between about 3.5% and about 5.5% of sulfur by weight. In another embodiment, the construction board may contain between about 0.5% and about 0.75% of sulfur by weight.

In an exemplary embodiment of the invention, the magnesium oxide based construction board may be manufactured from a plurality of constituents. At least one constituent may be magnesium oxide, which may have a purity of about 85% and a reactivity of about 85%. Another constituent may be magnesium chloride, which may have a purity of about 48% and a specific gravity of about 22 (±1). Another constituent may be multiple sheets of fiberglass mesh positioned throughout the interior of the construction board, often near the outer edge or plane of the construction board and parallel thereto.

Another constituent of the exemplary board may be perlite having a grain size of less than about 1 mm and a purity of about 92% and/or perlite powder (700) having a purity of about 99%. Another constituent may be wood powder, which may have a grain size of about 2 mm and a purity of about 98%. Another constituent may be calcium carbonate having a purity of about 98.8%. Carbonate may be present in the cement mixture used to form the board in a weight percentage of up to about 10%, 15%, 20%, 25%, 50%, or 75%, for example. Another constituent may be defoaming materials, which may include (C₆H₉)₃ PO₄ having a purity of about 98.5%. Another constituent may include sodium hydroxide (NaOH) having a purity of about 96%, which may be a solid that is melted and added to the construction board mixture for its waterproofing characteristics.

Another constituent of the exemplary board may include bone glue (a generally clear protein glue that may be made from animal bones) and/or rosin having a purity of about 96%, which may also be added for waterproofing characteristics. Another constituent that may be added to the construction board mixture includes ferrous sulphate (FeSO₄) at a purity of about 98%, which may operate to eliminate the need for a water bath during the manufacturing process.

Another constituent that may be added to the construction board mixture includes iron oxide yellow having a purify of about 92%. Another constituent that may be added to the construction board mixture includes phosphate (PO₄) having a purity of about 98.9%, which facilitates eliminating the need for the water bath. Another constituent that may be added to the construction board mixture includes acryl latex having a purity of about 91% (acrylate purity). Although exemplary purities are recited above, the inventors contemplate that the purity of the constituents may be in a range of about 6% above or below the exemplary purity, about 7% above or below the exemplary purity, about 10% above or below the exemplary purity, or about 15% above or below the exemplary purity.

Other chemical ingredients that may generally be included in the magnesium oxide-based construction board mixture may include magnesium chloride, wood shavings or powder, calcium carbonate as a binder, sodium hydroxide, bone glue, rosin, resin, tree sap, iron sulfate has a wood preservative, iron oxide, or phosphates as a weak acid to lower the pH to approximately 7. The phosphates also help with absorbing off gas oxygen in the magnesium oxide cement mixture.

The magnesium oxide used in the cement (board material) for the construction board of the invention may have a purity of between about 80% and about 95%, for example. The board mixture may have between 0.1% and about 50% calcium carbonate in one embodiment. In another embodiment the board, between about 1% and about 3% of the board mixture by volume may comprise calcium carbonate. Generally, the calcium carbonate percentage will be less than about 2.5%, as the calcium carbonate content causes the chlorine content of the board to increase, which is undesirable, as the chlorine reacts with the neighboring components to break down the board over time.

In another embodiment of the invention, the board constituents may include an element or molecule that reacts with the residual chlorine in the mix to essentially neutralize the impact of the chlorine. Chlorine is a highly reactive element, and undergoes reaction with a wide variety of other elements and compounds. Chlorine is a good bleaching agent, due to its oxidizing properties, and chlorine is soluble in water (which solution is called Chlorine Water) and this loses its yellow color in sunlight due to the formation of a mixture of Hypochlorous Acid and Hydrochloric Acid. Chlorine combines directly with most non-metals (except with Nitrogen, Oxygen and Carbon, C), and chlorine combines directly with all metals forming metal chloride sails. Thus, the inventors contemplate that any element or compound that is known to react and essentially neutralize the oxidizing effect of chlorine may be added to the construction board mix. For example, copper, zinc, nickel, and iron may be used to neutralize free chlorine in the construction board.

Table II illustrates the quantity (in kg) of board constituents for an exemplary soffit board, backer boards, and trim boards,

TABLE II

| | | 6 mm | 11 mm | 6 mm | 11 mm | 11 mm | 19 mm | 24 mm |
|---|---|---|---|---|---|---|---|---|
| | | Backer | Backer | Backer | Backer | Trim | Trim | Trim |
| Constituent | Soffit | (3 × 5 ft) | (3 × 5 ft) | (4 × 8 ft) | (4 × 8 ft) | (4 × 12 ft) | (4 × 12 ft) | (4 × 10 ft) |
| MgO | 12 | 4.8 | 8.75 | 10.2 | 18.7 | 32.92 | 56.86 | 59.85 |
| MgCl₂ | 5.5 | 2.5 | 4.64 | 5.4 | 9.9 | 15.26 | 26.36 | 27.75 |
| Mesh | .5 | .17 | .23 | .36 | .48 | 1.08 | 5.18 | 4.32 |
| Perlite | .3 | .15 | .28 | .31 | .56 | .85 | 1.47 | 1.55 |
| Perlite | .5 | .05 | .05 | .1 | .1 | .75 | .75 | .75 |
| Powder | | | | | | | | |
| Wood | .4 | .28 | .51 | .6 | 1.1 | 1.1 | 1.9 | 2.0 |
| Powder | | | | | | | | |
| CaCO₃ | 1.5 | .54 | 1 | 1.15 | 2.11 | 4.12 | 7.5 | 7.49 |
| Defoaming | .5 | .1 | .18 | .22 | .41 | 1.35 | 2.33 | 2.45 |
| NaOH | .13 | .06 | .11 | .13 | .23 | .36 | .62 | .65 |
| Boneglue | .16 | .08 | .15 | .16 | .29 | .44 | .76 | .8 |
| Rosin | .08 | .04 | .07 | .08 | .14 | .22 | .38 | .4 |
| FeSO₄ | .98 | .46 | .84 | .98 | 1.8 | 2.69 | 4.65 | 4.9 |
| Iron Oxide | .03 | .01 | .01 | .01 | .01 | .08 | .14 | .15 |
| Yellow | | | | | | | | |
| PO₄ | .3 | .09 | .16 | .2 | .37 | .81 | 1.4 | 1.47 |
| Latex | .15 | .01 | .01 | .01 | .01 | .4 | .69 | .73 |

Table III illustrates the quantity (in % by total weight) of board constituents for an exemplary soffit board, backer boards, and trim boards.

TABLE III

| | | 6 mm | 11 mm | 6 mm | 11 mm | 11 mm | 19 mm | 24 mm |
|---|---|---|---|---|---|---|---|---|
| | | Backer | Backer | Backer | Backer | Trim | Trim | Trim |
| Constituent | Soffit | (3 × 5 ft) | (3 × 5 ft) | (4 × 8 ft) | (4 × 8 ft) | (4 × 12 ft) | (4 × 12 ft) | (4 × 10 ft) |
| MgO | 51.98 | 51.23 | 51.62 | 51.28 | 51.67 | 52.73 | 51.23 | 51.93 |
| MgCl₂ | 24.1 | 27.12 | 27.34 | 27.15 | 27.36 | 24.44 | 23.75 | 24.08 |
| Mesh | 2.08 | 1.82 | 1.36 | 1.81 | 1.33 | 1.73 | 4.67 | 3.75 |
| Perlite | 1.35 | 1.61 | 1.65 | 1.56 | 1.55 | 1.36 | 1.32 | 1.34 |
| Perlite | 2.17 | .54 | .29 | .5 | .28 | 1.2 | .68 | .65 |
| Powder | | | | | | | | |
| Wood | 1.74 | 3.0 | 3.01 | 3.02 | 3.04 | 1.76 | 1.71 | 1.74 |
| Powder | | | | | | | | |
| CaCO₃ | 6.51 | 5.79 | 5.83 | 5.78 | 5.83 | 6.6 | 6.76 | 6.5 |
| Defoaming | 2.13 | 1.07 | 1.06 | 1.11 | 1.13 | 2.16 | 2.1 | 2.13 |
| NaOH | .56 | .64 | .65 | .65 | .64 | .58 | .56 | .56 |
| Boneglue | .69 | .86 | .88 | .8 | .8 | .7 | .68 | .69 |
| Rosin | .35 | .43 | .41 | .4 | .39 | .35 | .34 | .35 |
| FeSO₄ | 4.26 | 4.93 | 4.95 | 4.93 | 4.97 | 4.31 | 4.19 | 4.25 |
| Iron Oxide | .13 | .01 | .01 | .01 | .01 | .13 | .13 | .13 |
| Yellow | | | | | | | | |
| PO₄ | 1.3 | .96 | .94 | 1.01 | 1.02 | 1.3 | 1.26 | 1.28 |
| Latex | .65 | .01 | .01 | .01 | .01 | .64 | .62 | .63 |

Applicants note the each of the weights and percentages recited in Tables I and II above are exemplary and not intended to be limiting upon the scope of the invention. For example, the exemplary values noted in Table I and Table II may be increased or decreased by about 1%, 2%, 5%, 10%, or 15% without departing from the scope of the invention, and further, the values may include any value between the possible high and low numbers in the table (factoring in the possible±percentage variation). Thus, one possible range is between about 5% below the exemplary value and about 2% above the exemplary value, further, another possible range may be between about 3% above the exemplary value and about 10% above the exemplary value. In sum, each of the values noted above may form an endpoint of a range for the constituents of the magnesium oxide mixture of the invention.

In another exemplary embodiment of the invention, a method for manufacturing a construction board is provided. More particularly. FIG. 9 illustrates a flowchart of an exemplary method for manufacturing a construction board of the invention. The exemplary method begins at step 900, and continues to step 902 where a mold that is configured to support the manufactured construction board is cleaned and prepared to receive the magnesium oxide-based cement mixture thereon. For example, in embodiments of the invention where the mold includes a texture, the mold may be coated with a releasing agent prior to the magnesium oxide-based cement mixture being applied thereon. In other embodiments of the invention, for example, with a smooth surfaced board is desired, a slip sheet or other thin layer of material configured to prevent the magnesium oxide-based cement mixture from adhering or sticking to the mold, may be positioned on the surface of the mold before the magnesium oxide cement mixture is poured onto the mold. Another step that may be implemented to prepare the mold to receive the magnesium oxide-based cement mixture may include heating or cooling the mold to a particular processing temperature.

The method continues to step 904, were the chemical constituents used in the manufacturing process may be mixed together. For example, the magnesium oxide-based cement mixture described above may be mixed at step 904. The mixing process may include the addition of additives configured to optimize a particular type or size of board being manufactured. Exemplary additives include latex, foaming agents, de-foaming agents, preservatives, chlorine eaters, components configured to facilitate and support carbon capture and recycle, recycle board material, wood powder or shavings, fillers, and any other component that may be used to enhance properties of the manufactured construction board. In addition to the base magnesium oxide cement mixture, the jesso mixture, which is described above as a thin magnesium oxide-based cement mixture having little or no fillers therein, may also be mixed. The jesso mixture generally has a thinner consistency than the magnesium oxide-based cement mixture, as the jesso mixture generally contains fewer fillers than the base magnesium oxide cement mixture. Additionally, the jesso mixture may include additional liquid elements configured to further thin the mixture to make it more viscous.

Once the mold and mixtures are prepared, the method continues to step 906 where a thin jesso layer is deposited on the mold surface. The thickness of the jesso layer may be between about 1 mm and about 10 mm, for example. The jesso layer generally extends across or covers a substantial portion of the mold surface, in an embodiment of the invention where the mold includes side rails or vertically extending walls configured to contain the cement mixture is on the mold, then the jesso is generally deposited onto the mold in a manner that covers the entire surface area of the mold between the side rails or walls. In embodiments of the invention where the mold includes a texture, the jesso mixture is generally deposited onto the mold in a quantity sufficient to fill the recesses in the mold that form the texture, while also creating a thin layer of jesso above the primary plane of the mold that has a thickness up between about 1 mm and about 10 mm. In at least one embodiment of the invention, the mold may be actuated or vibrated to settle, smooth, or equally spread out the jesso mixture across the surface of the mold.

The jesso layer may be applied to the mold in a plurality of manners. For example, the mold may be linearly passed under an elongated jesso dispensing aperture that is configured to dispense a constant flow of jesso across the mold being passed under the dispensing aperture. The constant flow of the jesso material combined with a constant linear movement of the mold under the aperture creates a substantially uniform layer of jesso on the mold surface, where the jesso layer has a substantially uniform thickness and distribution across the surface of the mold. In other embodiments of the invention, the jesso material may be bulk deposited onto one or more locations of the mold surface, and thereafter, the bulk deposition of material may be spread across the surface of the mold to a substantially uniform thickness. The process of spreading the material across the surface of the mold may be done manually or by passing the mold under rollers or other mechanical device configured to evenly spread the jesso material across the surface of the mold. Mechanical devices that may be used include, but are not limited to, skimmers and other devices configured to remove excess material from the board stack being manufactured. Additionally, as noted above, actuation or vibration of the mold may also be used to spread the jesso.

Once the jesso layer has been deposited. The method continues to step 908 where a layer of reinforcing mesh is positioned on the jesso layer. The reinforcing mesh layer may include a fixed or woven type of mesh, and further, the mesh may be a fiberglass-type mesh, as described above. The process of positioning the mesh layer on the jesso layer may include tensioning the mesh layer into a substantially uniform plane while positioning the mesh layer onto the jesso layer. The mesh layer may be applied to the jesso layer by a roller positioned above the mold, where the roller is configured to linearly dispense with the mash on to the jesso layer as the mold is passed under the roller containing the mesh material.

Generally, the mesh layer is configured with a plurality of apertures therein, wherein the apertures are formed by the grid configuration of the mesh. The apertures may generally be configured and sized to allow the jesso layer to flow through the grid or apertures of the mesh layer. Thus, although the mesh layer is at least initially applied to the outermost surface of the jesso layer, in at least one embodiment of the invention the mesh layer is slowly consumed or brought into an interior portion of the jesso layer when the jesso material slowly transfers through the grid or apertures of the mesh. The mesh layer, when consumed by the jesso layer, is generally positioned near the middle of the jesso layer and not exposed to the outer surfaces of the jesso layer. In other embodiments of the invention the mesh layer may be positioned proximate the surface of the board material and may be visible from the exterior, i.e., the outer surface of the board may have a textured surface that corresponds to the texture of the mesh.

Once the mesh layer has been applied, the method continues to step 910, where the core magnesium oxide-based cement mixture is applied to the upper surface of the jesso mixture, which has at least partially consumed the mesh layer. The magnesium oxide-based cement mixture generally includes the cement composition along with a plurality of fillers, binders, and/or other enhancing constituents that are not generally present in the jesso mixture. Once the magnesium oxide-based cement mixture has been dispensed onto the jesso layer, the material stack may optionally be rolled or pressed to create a substantially planar upper surface. The magnesium oxide cement material may be deposited by an aperture and linear movement (as described above with regard to the jesso) or bulk dispensed and spread across the mold.

In another exemplary embodiment of the invention, step 910 may also include the addition of additional layers of woven mesh into the main or core layer of magnesium oxide-based cement. For example, step 910 may be broken down into a plurality of steps that include dispensing a mesh layer on to a first thin layer of magnesium oxide-based cement, and then dispensing a second and layer of magnesium oxide-based cement onto the mesh layer. This process may be repeated any number of times to provide a board core that includes a plurality of spaced mesh layers positioned therein. In an exemplary embodiment of the construction board of the invention, between about two and about eight independent mesh layers may be positioned in the magnesium oxide-based cement mixture that is the core of the construction board. Again, actuation or vibration may be used to smooth or spread the magnesium oxide base cement mixture, or alternatively, the mixture may be spread by hand or by pressing or rollers.

Once the core cement layer and the accompanying mesh layers have been deposited, the method continues to step 912, were another mesh layer may optionally be applied to the material stack. Once the mesh layer has been applied, a layer of jesso may be dispensed on to the mesh and allowed to flow through the apertures or grid formed by the mesh, as shown by step 914. Alternatively, the jesso layer of 914 may be applied before the mesh layer of 912 in at least one embodiment of the invention. Additional layers of jesso may be applied to the upper surface of the construction board to provide a substantially smooth outer surface, and further to conceal the mesh contained in the interior portion of the construction board. Further, once the final layer at jesso has been applied to the construction board, the entire stack may be pressed or roiled to a predetermined thickness. For example, the mold carrying a material stack may be passed under a roller to flatten the stack to a predetermined thickness, wherein the predetermined thickness generally correlates to the desired board thickness. Vibration or actuation may also be used to smooth, flatten, or spread the stack. The mesh layers positioned closest to the outer surface of the board may include mesh and/or paper material, a veneer, or a gortex-type material.

Once the final layer of jesso and mesh has been applied and the board has been either pressed or rolled to the desired thickness (optional), then the method continues to step 918, where the board may be put through a preliminary drying/curing process. The pressing to a desired thickness may be accomplished by compression plates, rollers, or other mechanical devices configured to control the thickness of a cement mixture or stack. For example, prior to the board being removed from the mold, the board may be temporarily dried or cured for an amount of time sufficient to allow the magnesium oxide-based cement mixture to harden to a state where the mixture is sufficiently hard to support its own weight. This preliminary drying and curing stage may be between about 3 and about 10 hours long, in embodiments of the invention where the magnesium oxide-based cement mixture includes constituents that cause an exothermic reaction to take place, the preliminary drying/curing phase may further include bathing the construction board in water or other cooling liquid to control (reduce) the temperature of the construction board during the curing process, however the bathing step is optional and likely unnecessary for board mixtures that are not exothermic. The bathing step may also be used to wash away impurities or secreted materials or constituents from the construction board.

Once the construction board has cured to a point where the magnesium oxide-based mixture is able to support its own weight without bending, breaking, or otherwise damaging the structure of the board itself, then the board may be removed from the mold, as illustrated in step 918. Once removed from the mold, the board may go through an additional (primary) drying or curing steps, and further may be introduced into additional water or cooling liquid baths (again, optional and likely used only with exothermic chemical reaction board constituents), as illustrated in step 920. This primary drying and curing process may take several days, generally about 3 and about 5 days, however, the curing process may last up to 30 days. The board may be cured in a controlled temperature environment. For example, the humidify and/or temperature of the board curing environment may be controlled to minimize the require curing time, in at least one embodiment of the invention, the boards are cured at a temperature of between about 70° F. and about 90° F. for about 3 to about 5 days. The environmental humidity for the curing process may be less than about 75% humidity, and in some embodiments, the humidity may be less than about 50% or less than about 40% for optimal curing. The curing process is generally calculated to end when the water content of the construction board is less than about 10%, or less than about 5%, or less than about 2%, for example.

Once the construction board is completely cured, the board may be finally sized, as illustrated in step 922. For example, in embodiments of the invention where the mold does not include upstanding side members configured to contain the magnesium oxide-based cement mixture to a predetermined size (width and length), then the construction board may be passed through one or more cutting devices, which may generally be radial saws, that are configured to cut the construction board into one or a plurality of specifically sized boards. In fact, even in embodiments of the invention where mold sides are used, the resulting construction board may still be cut into a plurality of smaller boards.

For example, a mold with upstanding sides may be configured to manufacture a 4′×8′ sheet of the magnesium oxide-based construction bard, however, this 4′×8′ sheet may be cut into a plurality of (8) 6 inch wide trim strips that are each 8′ long. Similarly, when a mold is used without upstanding side members, the magnesium oxide-based cement mixture may be pressed or rolled to a predetermined thickness across a substantial portion of the board. However, the perimeter portions of the board will generally be thinner as a result of the cement mixture expanding outward during the pressing or rolling operation and not being able to fill the entire volume between the bold and the press or roller. These thinner sections of the board may be trimmed off to yield a resulting board stock that has a continuous thickness and that can be cut into a plurality of uniform thickness boards. Further, the excess material cut from the board stock may be ground into small pieces and recycled into subsequent boards by adding the ground up pieces into subsequent magnesium oxide based board mixtures as a filler or other board constituent to reduce material costs and increase the efficiency of the manufacturing processes. The process of cutting the board to size may also include cutting or sanding the board to a desired thickness.

The method of manufacturing generally ends at step 924. However, the method (step 924) may also include a financial aspect of selling carbon credits corresponding to the CO₂ captured, recycled, or sequestered in the manufactured construction board. The carbon credits, which are further detailed herein, may be sold to enhance the profit margin or offset the cost of manufacturing the construction boards of the invention. The use of the carbon credits also may be used to enhance marketing of the construction boards of the invention as environmentally friendly or “green” boards.

Generally speaking, cement mixtures that may be used to manufacture the construction board of the invention are formed from the combination of magnesium oxide and magnesium chloride solution. This cement type is known by many different names, such as Sorel, magnesite and magnesium oxychlohde cement (MOC). Magnesium oxychloride has many properties which are superior to that of conventional cements, such as Portland cement. For example, MOC does not need wet curing, has high fire resistance, low thermal conductivity, and good resistance to abrasion, MOC also has high transverse and crushing strengths; 48-69 MPa is not uncommon. Additionally, MOC bonds to a wide variety of inorganic and organic aggregates, such as, saw dust, wood flour, marble flour, sand, pulverized rubber, gravel, ground trash, and many other components and compounds, thus resulting in a cement that has high early strength, insecticidal properties, resiliency, electrically conducting and is unaffected by oil, grease and paints.

The main bonding phases found in hardened cement pastes are Mg(OH)₂, 5Mg(OH)₂.MgCl₂.8H₂O (5-form) and 3Mg(OH)₂.MgCl₂.8H₂O (3-form). Five-form may be made using a molar ratio of MgO:MgCl₂H₂O 5:1:13. A slight excess of MgO and an amount of water as close as possible to theoretical required for formation of the 5-form and hydration of the excess MgO to form Mg(OH)₂ is often used. The 5-form phase appears about two hours after the cement is mixed with water and results in the formation of needlelike crystals, which interlock in a rapid growth. At the stage when crystal growth becomes crowded due to lack of space, the crystals then begin to inter-grow into a denser structure. The strength of the bond of MOC may increased for some board applications by the formation of 5-form MIX, which has good space-filling properties and forms a dense microstructure with minimum porosity. However, other boards with varying properties may be formed by injecting additional components into the MOC mixture, as generally described above.

The reactivity of the MgO can greatly influence the reaction rates. The magnesium oxide used in MOC based boards may conform to certain requirements of chemical and physical properties. For example, conditions of calcination, particle size and active lime content can be controlled to vary the properties of the resulting manufactured board. For example, the active lime content is defined as the lime available to react with the magnesium chloride, and includes calcium oxide, calcium hydroxide and some forms of calcium silicate. This reaction results in an increase in volume change in the cement during the setting process and will result in decreased strength and durability. When the active lime content is generally less than 2.5%, the increased volume effect may be minimized and can also be compensated for by the addition of magnesium sulfate to the magnesium chloride gauging solution where the sulfate reacts with the active lime to form calcium sulfate.

MCO based boards have also shown to exhibit fire resistance. The water of hydration and hydroxyl water associated with the plain MOC 5-form and 3-form (without additives configured to increase the fire retardencey of the material) have been shown to be 44 and 49% respectively. When the MOC boards are heated to 297° C., the chemically bound water will be converted to steam with an energy requirement of about 1000 BTU per pound of water released. The MOC cement beneath the surface exposed to the heat will not be heated above this temperature until all of the water has been released and driven from the cement. Because of the high energy requirement for this process to occur, the insulative effect from the water of hydration is considerable and constitutes the principle means of insulation. Thermally decomposed MOC cement is primarily MgO and as such has a high reflectivity, which is also a significant factor in the overall insulative capability of magnesium oxychloride cement. It has been calculated that a 5 cm thickness of typical MOC cement with a density of 960 kg m⁻³, containing approximately 35% bound water and no fillers, required over 6 hours for the non-heated face to reach a temperature of 1000° F. (538° C.).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We Claim:

1. A method for manufacturing a cement based board, comprising:
mixing a first cement mixture comprising magnesium oxide and magnesium chloride;
mixing a second cement mixture comprising magnesium oxide, magnesium chloride, a binding agent, and at least one filler, the second cement mixture being thicker in consistency than the first cement mixture;
dispensing a first layer of the first cement mixture onto a mold;
dispensing a first layer of reinforcing mesh onto the first layer of the first cement mixture, the reinforcing mesh being sized to allow the first cement mixture to at least partially pass through the reinforcing mesh layer;
dispensing a layer of the second cement mixture over the first layer of the first cement mixture;
dispensing a second layer of the first cement mixture onto the layer of the second cement mixture;
dispensing a second layer of reinforcing mesh onto the second layer of the first cement mixture and allowing at least a portion of the second layer of the first cement to flow through the mesh; and
drying the cement based board.

2. The method of claim 1, further comprising cutting the cement based board to size.

3. The method of claim 1, wherein the mold includes a textured surface configured to impart a texture onto one side of the cement based board.

4. The method of claim 1, wherein the mold included upstanding side portions configured to contain the cement mixtures in a predefined area that corresponds to a particular board size to eliminate post cure cutting of the cement based board to a particular size.

5. The method of claim 1, further comprising cutting the dried cement based board to size.

6. The method of claim 1, wherein the first cement mixture comprises jesso.

7. The method of claim 1, further comprising rolling, skimming, compressing, or sanding at least one layer of the cement based board to a predetermined thickness.

8. The method of claim 7, wherein the roiling process is conducted after the second layer of reinforcing mesh is dispensed.

9. The method of claim 1, wherein dispensing the layer of the second cement mixture further comprises dispensing alternating layers of the second cement mixture and reinforcing mesh.

10. The method of claim 1, wherein the filler comprises a carbonate material.

11. The method of claim 1, wherein the filler comprises ground up trash material.

12. The method of claim 1, wherein the filler comprises at least one of ground up rubber, plastic, glass, wood, rock, metals, and metal alloys.

13. A method for manufacturing a cement based construction board, comprising:
mixing a magnesium oxide based cement mixture;
dispensing a thin layer of the magnesium oxide based cement mixture onto a mold;
positioning a reinforcing mesh layer on the thin layer and allowing a portion of the thin layer to pass through the reinforcing mesh layer;
dispensing a thick layer of the magnesium oxide based cement having a filler material in the cement mixture onto the previously deposited thin layer containing the reinforcing mesh;
dispensing another thin layer of the magnesium oxide based cement mixture onto the thick layer; and
positioning another layer of reinforcing mesh on the thin layer and allowing a portion of the thin layer to pass through the reinforcing mesh.

14. The method of claim 13, further comprising positioning at least one reinforcing mesh layer within the thick layer of the magnesium oxide based cement.

15. The method of claim 13, further comprising roiling a stack of the thin and thick layers of material to a substantially uniform thickness.

16. The method of claim 13, further comprising drying the layers to cure the cement mixture.

17. The method of claim 13, further comprising removing the layers from the mold.

18. The method of claim 17, further comprising cutting the layers removed from the mold into predetermined board sizes.

19. The method of claim 13, wherein the mold includes a texture that is to be imparted to an outer surface of the construction board.

20. The method of claim 13, further comprising bathing the board in an aqueous solution to cure the cement mixture.

21. A method for manufacturing a cement based construction board, comprising:
mixing a first cement mixture of magnesium oxide based cement;
mixing a second cement mixture of magnesium oxide based cement having a filter material, the second cement mixture being thicker than the first cement mixture;
lubricating a substantially planar mold with at least one of a liquid lubricant, a non-liquid lubricant, or a dry lubricant;
dispensing a thin layer of the first cement mixture onto the substantially planar mold;
positioning a layer of reinforcing mesh on an upper surface of the thin layer and allowing at least a portion of the thin layer to permeate the reinforcing mesh;
dispensing at least one thick layer of the second cement mixture onto the thin layer;
dispensing another thin layer of the first cement mixture onto the thick layer;
positioning a layer of reinforcing mesh on the thin layer and allowing the and allowing at least a portion of the thin layer to permeate the reinforcing mesh;
pressing the layers of cement to a predetermined and substantially uniform thickness;
drying the layers of cement for a predetermined period of time;
removing the layers of cement from the mold; and
cutting the layers of cement into predetermined board sizes.
